(19) United States
(12) Patent Application Publication
(10) Pub. No.: US 2007/0028742 A1
(43) Pub. Date: Feb. 8, 2007

(54) Axially-displaceable cutter and cutting gap adjustment

(76) Inventors: Ralf Peter Mueller, Kempten (DE); Joerg Schmeiser, Kempten (DE)

Correspondence Address: PERMAN & GREEN, 425 POST ROAD, FAIRFIELD, CT, 06824, US

(21) Appl. No.: 10/565,871

(22) PCT Filed: Jul. 23, 2004
(86) PCT No.: PCT/EP04/08265

§ 371 Date: Jul. 27, 2006

(30) Foreign Application Priority Data
Jul. 23, 2003 (DE) 103 33 661.3
Dec. 16, 2003 (DE) 103 59 149.4

(51) Int. Cl. B26D 1/14

(52) U.S. Cl. 83/676; 83/932

(57) ABSTRACT

The invention relates to a slicing device for slicing foodstuffs (1), in particular, sausages, meat or blocks of cheese with a rotating cutting blade (2), which may be displaced parallel to the rotation axis (3) thereof. The invention further relates to a method for the axial displacement of a cutting blade (2) and the use of axially-displaceable counterweights (4) for stabilisation of the action of a cutting blade (2) on a cutting machine, the use of the axial displacement of the cutting blade (2) of a slicing machine, for adjustment of the initial point and the use of the axial displacement of the cutting blade (2), for adjustment of the wheel gap between the cutting blade (2) and a cutting strip.

The present invention relates to a slicing device for slicing food products, in particular sausage, meat or cheese blocks, having a rotating cutting blade mounted so as to be displaceable parallel to its axis of rotation. The present invention relates to a method for axial displacement of the cutting blade and to the use of axially displaceable counterweights for stabilising running of a cutting blade of a cutting machine, to the use of the axial displacement of the cutting blade of a slicing machine for adjusting the zero point and to the use of the axial displacement of the cutting blade for adjusting the cutting gap between the cutting blade and a cutting guide.

These days, slicing machines sever slices from a block-form food product, for example a sausage, ham or cheese block, at relatively high rates. The food products lie on a product support and are conveyed gradually or continuously thereby towards the cutting blade. To achieve very high cutting performance, it is necessary to provide idle cuts, i.e. movements of the cutting blade during which no slice is severed from the block of food product. To produce idle cuts, it is possible on the one hand for the food product to perform a retraction stroke directed away from the cutting plane. It is also possible to produce an idle cut by preferably axial displacement of the blade.

Such axial displacement of the cutting blade is taught for example in patent specification no. 15 49 52, wherein the axial retraction stroke of the blade of the slicing machine described therein is produced by a cam disk coupled to the drive, such that axial displacement of the blade is impossible independently of the rotational speed of the blade. A further slicing machine with an axially displaceable blade is taught in DE 4214264 A1, wherein in the present case axial movement is effected by an actuating cylinder, such that movement is only possible between two end points and not adapted to the particular product.

The object of the present invention is therefore to provide a slicing machine which does not exhibit the disadvantages of the prior art.

The object is achieved according to the invention by a slicing machine according to claims 1 and 3. Preferred embodiments of the slicing machine according to the invention are described in subordinate claims 2 and 4 to 9.

According to the invention, the slicing machine comprises a rotating cutting blade, which is mounted so as to be displaceable parallel to its axis of rotation. Displacement of the cutting blade is effected according to the invention by a feedback-controlled drive. It was extremely surprising to the person skilled in the art and not at all expected that very precise, very rapid axial displacement of the cutting blade is possible with such a drive. The position of the cutting blade relative to its zero point is known at all times. The feedback-controlled drive makes it possible to adapt the axial displacement, in particular with regard to distance and acceleration, to the particular instance of use. The optimum is a function inter alia of cutting efficiency, of the product, in particular of product geometry and product temperature, of blade geometry, of the position of the blade relative to the product and/or of slice thickness. Furthermore, the slicing machine according to the invention makes it possible to achieve the widest possible range of displacement profiles, for example the axial displacement may take a sinusoidal course. The optimum displacement of the cutting blade may be stored in a computer associated with the cutting machine. The slicing machine according to the invention is simple and economic to produce and operate.

In a preferred embodiment, the slicing machine comprises a counterweight, which may be displaced in the opposite direction from the cutting blade. This embodiment of the present invention has the advantage that the acceleration forces and moments are suppressed during axial displacement of the blade, such that the slicing machine is prevented to the greatest possible extent from vibrating.

Through separate adjustment of the counterweight independently of the axial displacement of the blade, forces and/or moments which arise for example as a result of blade imbalances caused by wear or sharpening may be eliminated. This adjustment of the blade takes place after attachment of the blade or during operation. The mass of the counterweight does not have to correspond to the mass of the cutting blade. Furthermore, the counterweight does not have to be symmetrical, in particular not rotationally symmetrical.

The present invention further provides a slicing machine for slicing food products, in particular blocks of sausage, meat or cheese, having a rotating cutting blade, which is mounted so as to be displaceable parallel to its axis of rotation, wherein it comprises a counterweight which is displaceable in the opposite direction from the cutting blade.

This slicing machine according to the invention has the advantage that acceleration forces or moments which arise during axial displacement of the blade are compensated. As a consequence, the slicing machine runs virtually without vibration, such that in particular the machine frame may be of substantially lighter construction. Furthermore, the cutting blade runs substantially more smoothly, such that more precise cuts are possible. Through separate adjustment of the counterweight independently of the axial displacement of the blade, forces and/or moments which arise for example as a result of blade imbalances caused by wear or sharpening may be eliminated. This adjustment of the blade takes place after attachment of the blade or during operation.

In a preferred embodiment, displacement of the cutting blade and of the counterweight is effected in each case by a feedback-controlled drive. This feedback-controlled drive has the advantage of making possible very precise, very rapid axial displacement of the cutting blade and the counterweight. The positions of the cutting blade relative to its zero point and of the counterweight are known at all times. The feedback-controlled drive makes it possible to adapt the particular axial displacement, in particular with regard to distance and acceleration, to the particular instance of use. Optimum displacement of the cutting blade is a function inter alia of cutting efficiency, of the product, in particular of product geometry and product temperature, of blade geometry, of the position of the blade relative to the product and/or of slice thickness.

Furthermore, the slicing machine makes it possible to achieve the widest possible range of displacement profiles, for example the axial displacement may take a sinusoidal course. The optimum displacement of the cutting blade and counterweight may be stored in a computer associated with the cutting machine. The slicing machine according to the invention is simple and economic to produce and operate.

Preferably, however, the slicing machine comprises just one preferably feedback-controlled drive for displacement of the cutting blade and of the counterweight. This embodiment has the advantage that just one drive is required for both movements. Reference is made to the above statements with regard to the advantages of feedback-controlled drive of the displacement.

The following statements apply to both the above-stated slicing machines according to the invention.

Any blade known to the person skilled in the art is suitable as cutting blade. Mention will be made here, by way of example, only of the circular blade, helical blade and crescent-shaped blade. The circular blade advantageously rotates in planetary manner. The blade is set in rotation by a drive. This drive is preferably feedback-controlled.

The counterweight may be any weight with which it is possible to eliminate the acceleration forces or acceleration moments and/or to eliminate forces or moments caused by blade imbalances or the like. The person skilled in the art will recognise that the mass of the counterweight does not have to correspond to the mass of the cutting blade. The same applies to the acceleration time profile and the displacement distance of the counterweight, which do not have to correspond to the acceleration profile or the axial displacement respectively of the blade. Furthermore, the person skilled in the art will recognise that the counterweight does not have to be symmetrical, in particular not rotationally symmetrical.

Displacement of the blade and/or of the counterweight is preferably to the greatest possible extent without play.

Displacement of the cutting blade and/or of the counterweight preferably takes place independently of the rotational speed of the cutting blade.

In another preferred embodiment of the slicing machine according to the invention, the cutting blade comprises a drive shaft and the cutting blade and/or the counterweight are mounted displaceably along the drive shaft. The drive shaft preferably comprises a controllable drive.

Furthermore, displacement of the cutting blade and/or of the counterweight is preferably effected with a spindle, which is particularly preferably arranged within the drive shaft. This spindle is preferably capable of feedback-controlled drive and preferably interacts with the thread of at least one sleeve (nut), which is connected with the cutting blade or with the counterweight. However, the slicing machine preferably comprises two sleeves, wherein one interacts with the cutting blade and one with the counterweight. These sleeves preferably have different threads, wherein the threads preferably differ in thread direction and/or lead angle. This embodiment of the present invention makes it possible for both the cutting blade and the counterweight to be displaced with one drive. The connection between the sleeves and the spindle is preferably to the greatest possible extent without play. This may be achieved for example by pretensioning of the sleeves, such that they always lie against the same flank of the spindle.

Preferably, the displacement mechanism for the blade and/or for the counterweight undergoes forced temperature control, preferably cooling. Very particularly preferably, the drive of the cutting blade and/or its bearing system is additionally forcibly cooled. The respective temperature control may be effected using liquids, preferably aqueous liquids or oil, and/or gas.

The present invention further provides a method for axial displacement of cutting blades during operation, in which a counterweight is displaced in the opposite direction from the cutting blade.

The method according to the invention has the advantage that no or only slight vibration occurs during displacement of the cutting blade. The method according to the invention is simple and cheap to carry out.

Preferably, displacement of the cutting blade and of the counterweight takes place synchronously.

It is also preferable for displacement of the cutting blade or of the counterweight to take place with one drive.

The present invention further provides the use of axially displaceable counterweights to stabilise running of a cutting blade of a slicing machine.

It was extremely surprising to the person skilled in the art and not at all expected that forces and/or moments caused for example by wear or sharpening may be compensated by the displacement of counterweights.

The present invention further provides the use of axial displacement of a cutting blade to adjust the zero point of the cutting blade. The zero point of the cutting blade is the point at which the blade finds itself no longer in contact with the cutting guide.

This use according to the invention has the advantage that adjustment of the zero point relative to the so-called cutting guide may take place virtually automatically. The position of the cutting guide has only to be changed extremely rarely, such that adjustment of the zero point, which has to be performed each time the blade is sharpened, may be carried out automatically.

Preferably, when the zero point is adjusted, the torque of the blade drive is measured. As soon as this increases, a control unit associated with the slicing machine recognises that there is contact between the cutting blade and the cutting guide and moves the blade away from the cutting guide again until the torque has reduced again accordingly. This point is the new zero point. The zero point may be stored and used for example for automatic adjustment of the cutting gap.

Adjustment of the zero point may take place on machine start-up or during operation. For example, the zero point may be checked at regular intervals during operation of the machine and optionally readjusted.

The present invention further provides feedback-controlled axial displacement of the cutting blade for adjustment of the cutting gap between the cutting edge of the cutting blade and a cutting guide.

This use according to the invention has the advantage that the cutting gap may be modified during operation or adapted to altered operating conditions. This makes it possible to produce the smallest possible cutting gap and thus very constant slice thicknesses.

Preferably, use according to the invention compensates expansion of the blade resulting from thermal expansion or centrifugal forces and wear caused by operation, in order to produce a slice thickness which as far as possible remains uniform.

It is also preferred for the cutting gap to be adjusted automatically via a display and no longer to require measurement or adjustment by hand.

The mechanical behaviour of the blade is preferably stored as a model and/or by means of characteristic diagrams in the machine control system, for example a computer. These data are used for adjustment or readjustment of the cutting gap when the cutting blade is in operation, such that at any time during operation, i.e. for example at any rotational speed and at any temperature, it is possible to operate with an at least virtually constant cutting gap.

The present invention further provides a device for slicing food products having a blade exhibiting a cutting plane and driven in rotation by a drive shaft and having a cutting edge, the blade being mounted so as to be displaceable parallel to its drive shaft for adjustment of the cutting gap between the cutting plane and the cutting edge and the device comprising an adjusting means with which the cutting gap may be established.

It was extremely surprising to the person skilled in the art and not at all expected that it would be possible with the device according to the invention to effect automatic adjustment of the cutting gap of a slicer. The device according to the invention is simple and economic to produce and operate.

According to the invention, the device for slicing food products comprises an adjusting means with which the cutting gap may be fixed. For this purpose, the adjusting means is brought into a given position and then the blade is displaced axially until it comes into contact with the adjusting means or until a given distance exists between the adjusting means and the cutting plane of the blade. The distance between the cutting plane and the cutting edge then corresponds to the desired cutting gap.

Preferably, the adjusting means is therefore an adjusting limit stop, towards which the blade moves by axial displacement. As soon as the blade comes into contact with the adjusting limit stop, axial displacement of the blade is terminated.

Preferably, the adjusting limit stop may be moved between a basic position and an adjusting position. In the adjusting position, adjustment of the cutting gap takes place. In the basic position, the adjusting limit stop is at a certain distance from the blade. This embodiment of the present invention has the advantage that slicing of the food product block is not impaired by the adjusting limit stop.

Adjustment of the adjusting limit stop between the basic and the adjusting positions may take place in any manner familiar to the person skilled in the art. Only manual adjustment is mentioned here by way of example. However, adjustment is preferably effected by an actuator, such that very precise positioning of the adjusting means and thus very precise adjustment of the cutting gap is possible.

Detection of contact between the blade and the adjusting means may take place in any manner familiar to the person skilled in the art. Preferably, however, the adjusting limit stop comprises a contact sensor.

Preferably, axial displacement of the blade is effected by means of a motor, preferably a servomotor. In this embodiment of the device according to the invention, the current consumption of the motor may be used to detect contact with the adjusting means.

In a preferred embodiment of the present invention, the position of the adjusting means, preferably of the adjusting limit stop, and thus the width of the cutting gap may be selected particularly preferably by means of a display. The machine operator selects the desired cutting gap on the display and the adjusting limit stop travels automatically into the corresponding position when the cutting gap is next adjusted.

Adjustment of the cutting gap preferably takes place when the blade is at a standstill. Adjustment of the cutting gap may also take place, however, when the blade is rotating, for example in order to compensate changes to the cutting plane caused by rotational speed and/or temperature.

The device according to the invention has the advantage, in particular, that the axial position of the blade no longer has to be changed after it has come into contact with the adjusting limit stop or after detection of a certain distance between the blade and the cutting edge.

The present invention further provides a method for adjustment of the cutting gap using the device according to the invention, in which an adjusting limit stop is moved from its basic position into its adjusting position corresponding to the desired cutting gap and the blade is displaced axially until it comes into contact with the adjusting limit stop.

The method according to the invention is simple and cheap to carry out. With the method according to the invention, any desired cutting gap, which may for example be preselected on a display, may be set before or during operation of the blade.

Preferably, the adjusting limit stop is brought into its basic position after adjustment of the cutting gap.

The present invention further provides a device for slicing food products, having a rotating cutting blade, which is displaceable parallel to its axis of rotation, wherein displacement is effected with at least one means comprising a first and second end, the position of which relative to one another may be modified.

It was extremely surprising to the person skilled in the art and not at all expected that it would be possible with such simple means to move the blade to and fro between two positions.

The means is preferably a coupling rod or a leaf spring.

It is also preferable for the first and the second end of the means, for example the coupling rod, to be twisted relative to one another, such that the length thereof relative to the axis of rotation is reversibly reduced.

In another preferred embodiment of the present invention, the means, for example a leaf spring, is bent and released again.

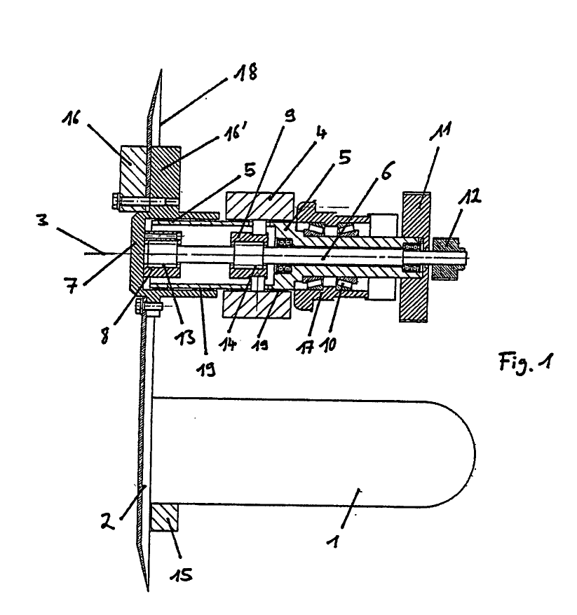

The inventions are explained below with reference to FIGS. 1-9. These explanations are given merely by way of example and do not restrict the general concept of the invention.

FIG. 1 is a schematic diagram of the slicing machine according to the invention with one spindle.

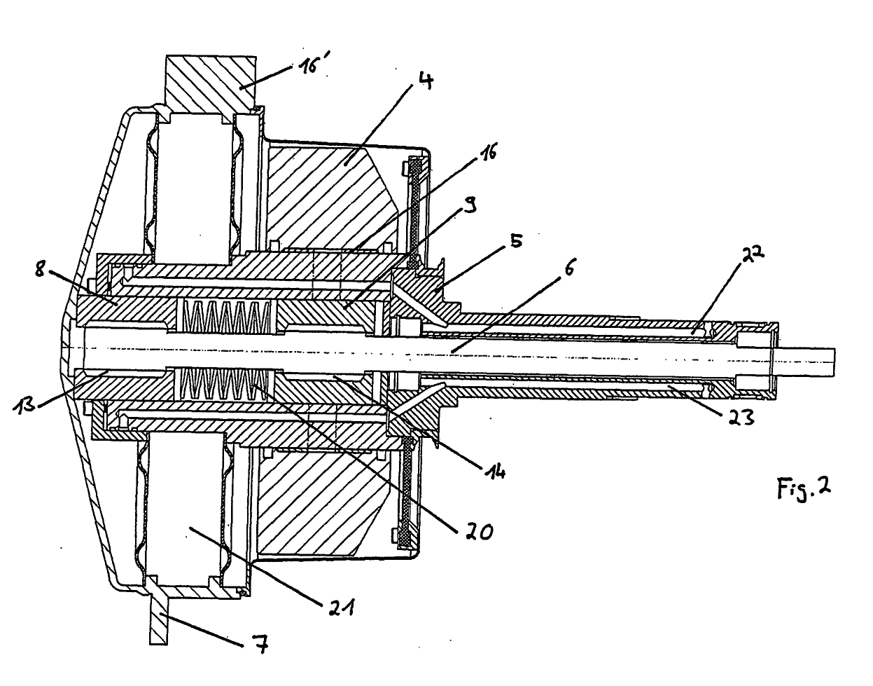

FIG. 2 is a further schematic diagram of the slicing machine according to the invention with one spindle.

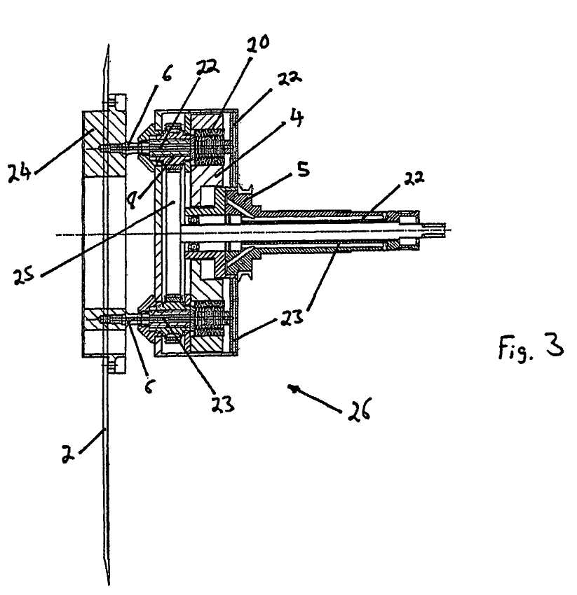

FIG. 3 is a schematic diagram of the slicing machine according to the invention with three spindles.

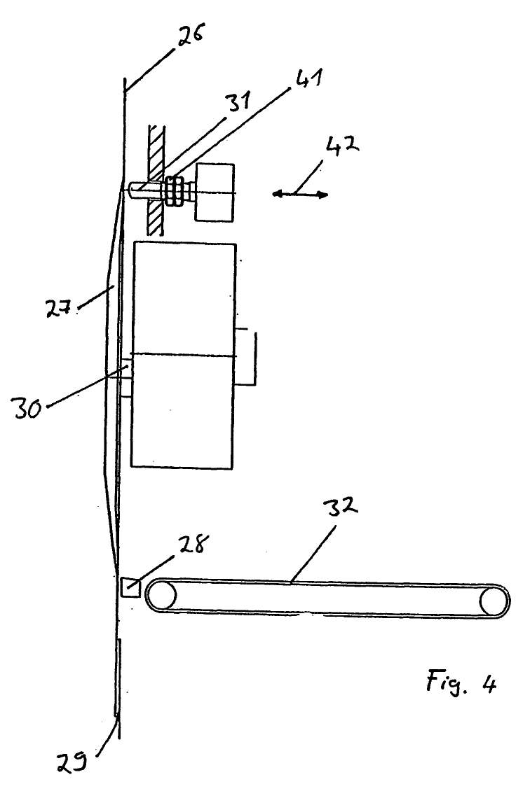

FIG. 4 shows the device according to the invention with an adjusting limit stop in its basic position.

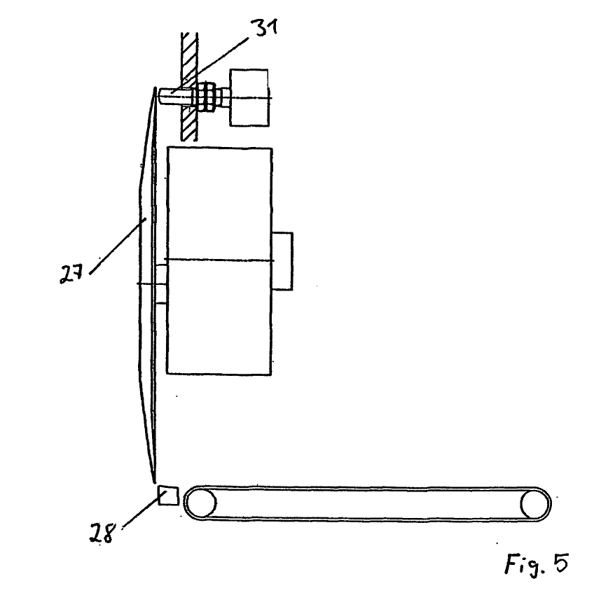

FIG. 5 shows the device according to the invention with the adjusting limit stop in the adjusting position.

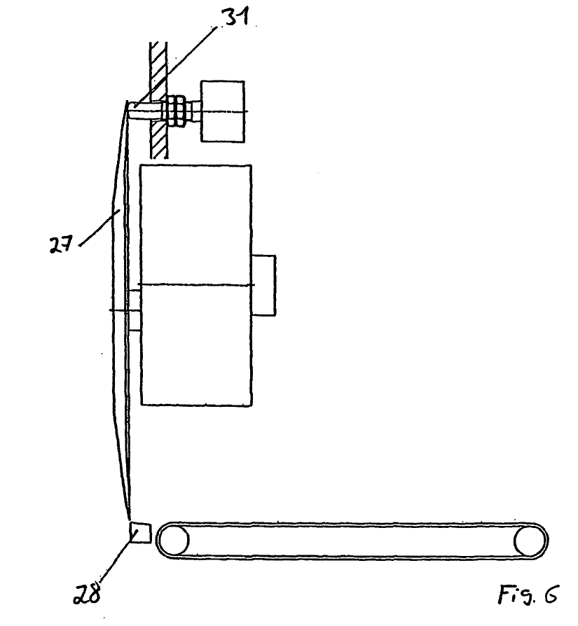

FIG. 6 shows contact between the adjusting limit stop and the blade.

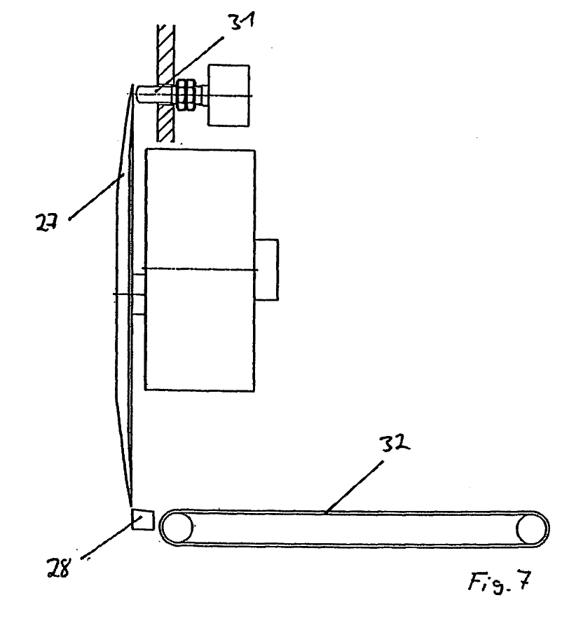

FIG. 7 shows the adjusting limit stop having been returned to the basic position.

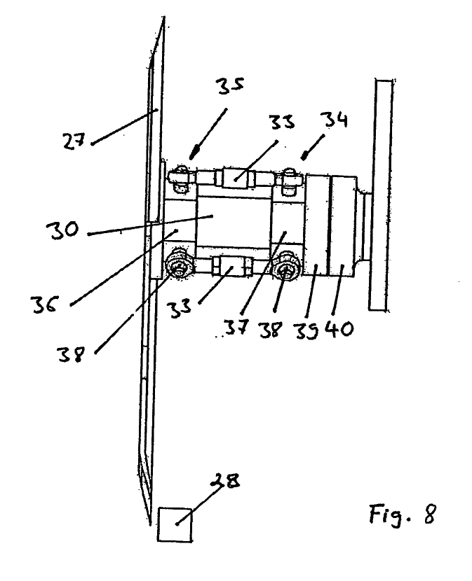

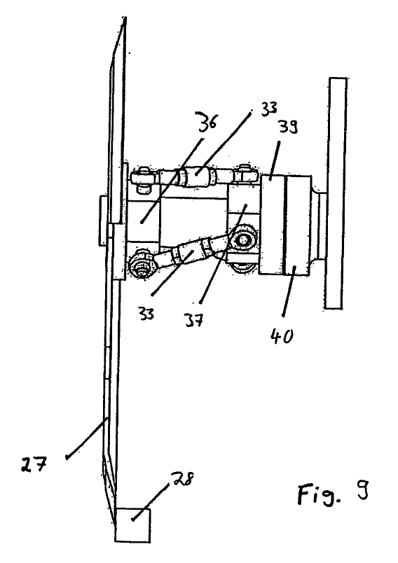

FIG. 8 and FIG. 9 show a device according to the invention for axial displacement of a blade.

FIG. 1 is a schematic diagram of the slicing machine according to the invention. The food product 1 lies on a support (not shown) comprising a cutting guide at its front end 15. The blade 2, with which slices are severed from the food product 1, comprises a cutting edge 18, which interacts with the cutting guide 15 during severing of the slices of food product. A hub 7 allows the blade 2 to be mounted axially displaceably but non-rotatably on two bushes 19 on the drive shaft 5. The drive shaft 5 is in turn mounted rotatably by means of bearings 10 on a machine frame 17. The drive shaft 5 is driven by means of the toothed belt wheel 11, which interacts with a feedback-controlled drive (not shown), for example a servomotor. Likewise, the counterweight 4 is mounted non-rotatably but axially displaceably on two bushes 19 on the drive shaft 5. Inside the shaft 5 there is located a spindle 6, which is connected via the toothed belt wheel 12 to a feedback-controlled drive (not shown), in this case a servomotor. Arranged on the spindle 6 are the sleeves 8 and 9, which each have an internal thread 13, 14 which interacts with the spindle 6. The thread 13 is a right-hand thread while the thread 14 is a left-hand thread. In addition, the threads differ in pitch. The person skilled in the art will recognise that the latter feature does not have to be the case. The sleeve 8 is connected with the hub 7, on which the blade 2 is arranged. The person skilled in the art will recognise that the hub 7 and the sleeve 8 may also be made in one piece. The sleeve 9 is connected with the counterweight 4. Here too, a one-piece construction is feasible. As a rule, the shaft 5 and the spindle 6 rotate at the same speed during slicing of the food product, such that the sleeves 8, 9 are in a stationary position relative to the spindle 6. If axial displacement of the blade 2 and of the counterweight 4 is desired, the rotational speed of the spindle 6 or of the drive shaft 5 is changed in such a way that they no longer run at the same speed, such that the sleeves 8, 9 move relative to the spindle 6. Due to the different turn directions of the threads 13, 14 of the sleeves 8, 9, the cutting blade and the counterweight each move in different directions, such that forces or moments which are brought about by the respective movements are cancelled out. In the present case the pitch of the thread 14 of the sleeve 9 is greater than the pitch of the thread 13 of the sleeve 8, such that the counterweight 4 may be smaller than the mass of the cutting blade. The person skilled in the art will recognise that the counterweight 4 does not have to be rotationally symmetrical, such that imbalances of the blade may be compensated with the counterweight. The person skilled in the art will additionally recognise that it may also be possible for the counterweight 4 to be moved along the spindle independently of the cutting blade. Since, in the present case, the blade is not rotationally symmetrical, the hub 7 comprises a balance weight 16′ in its upper region, on which balance weight 16′ a balance weight 16 is additionally arranged to ensure balancing of the blade. The person skilled in the art will recognise that the balance weights 16, 16′ are arranged to the right and left of the blade, in order to prevent the blade from wobbling. The person skilled in the art will additionally recognise that the balance weights 16, 16′ do not have to be arranged directly on the blade. For example, it is advantageous for the blade 2 to be displaced axially without the balance weights 16, 16′.

Since the exemplary slicing machine comprises feedback-controlled drives, this may be used for adjustment of the zero point of the cutting blade. For this purpose, the blade 2 is firstly set in rotation while at a distance from the cutting guide 15 and slowly moved in the direction of the cutting guide 15. In the process, the torque required for constant drive of the cutting blade 2 is measured, for example. As soon as this torque increases, i.e. the cutting blade is in engagement with the cutting guide 15, the axial movement of the blade is stopped and optionally reversed incrementally. The setting located in this way is the new zero point. This embodiment has the advantage that the cutting guide does not have to be displaced relative to the blade, as in the prior art, and that location of the zero point may be effected automatically in the slicing machine according to the invention and be repeated during the slicing process. The zero point is stored by the slicing machine according to the invention in a control unit associated with the machine and may be used for adjustment of the cutting gap.

Furthermore, the feedback-controlled drive may be used for adjustment or readjustment of the gap width. The person skilled in the art will recognise that the cutting blade 2 is shaped in the manner of a key. During operation of the cutting blade 2, the latter expands for example due to thermal effects and/or centrifugal forces. The degree of expansion is accordingly a function inter alia of the speed of the cutting blade and is either known to the person skilled in the art or measurable. In the case in particular of a slicing machine in which the rotational speed of the cutting blade is not constant, but also after a cold start, expansion may be balanced by a relative movement between spindle and drive shaft, such that with the slicing machine according to the invention cutting may be performed with a constant cutting gap during the entire cutting process and thus food product slices may be achieved which are of a very constant thickness. Through automatic adjustment or readjustment of the cutting gap, cutting may be performed with substantially smaller cutting gaps than in the prior art, which has a positive effect on cutting quality. The drive 5, 7 of the blade 2 and/or the adjusting mechanism 6, 8, 9 of the blade 2 and/or of the counterweight 4 may be temperature-controlled, preferably cooled, in the present slicing machine.

FIG. 2 is a further schematic diagram of the slicing machine according to the invention with a spindle 6. The slicing machine corresponds substantially to the slicing machine according to FIG. 1, such that the statements made in relation thereto also apply here. In the present case, however, the slicing machine comprises a spring 20, which interacts with the sleeves 8, 9 and pretensions them in such a way that the thread 13, 14 thereof interacts in each case only with one flank of the thread of the spindle. In this way, the play between the sleeves 13, 14 and the spindle 6 is reduced at least to the greatest possible extent. Furthermore, in the present case the hub 7 is not mounted on bushes but rather on disks 21. The disks deform on axial displacement of the hub 7. The disks may at the same time assume the function of an axial spring for play-free pretensioning of the sleeve 8. In addition to the disks illustrated with circumferential beads, any desired slotted disks may also be used. Mounting with disks has the advantage that no friction and thus no heat and no wear arise. In addition, the present illustration reveals details relating to temperature control, preferably cooling. The temperature control medium, in the present case water, is fed via the channels 22 to the slicing machine and then conveyed into the region in which mounting of the blade and displacement of the blade 2 and of the counterweight 4 occur. Once these regions have been temperature-controlled, the temperature control medium is conveyed out of the slicing head via the channels 23.

FIG. 3 is a schematic diagram of the slicing machine according to the invention with three spindles. In the present case, the blade is arranged on a blade holder 24, which is capable of axial displacement. The blade holder 24 comprises a balance weight. In principle, axial displacement of the blade holder takes place as illustrated in FIG. 1, except that in the present case axial displacement is not effected by one but rather by at least 3 spindles, which each interact with two sleeves, wherein the spindles are arranged non-rotatably and the sleeves 8, 9 (only one is shown) are driven by the toothed wheel 25. One sleeve has a right-hand thread and one a left-hand thread. During operation, the rotor 26 driven by the drive shaft 5 and the toothed wheel 25 rotate at the same speed and in the same direction. For axial adjustment of the blade holder 24 or of the counterweight 4, the rotational speed of the toothed wheel 25 or of the rotor is modified such that the spindle and thus the blade holder 24 or the counterweight 4 move in the desired direction. The person skilled in the art will recognise that the spindle 6 may also be driven and the sleeves 8, 9 may be non-rotatable. Furthermore, the person skilled in the art will recognise that each spindle 6 or sleeve 8, 9 may be driven individually. In the present case too, the displacement mechanism is temperature-controlled. For this purpose, a temperature-control medium, preferably water, is guided through the channel 22 and an axial bore in each spindle and then conveyed away again through the channel 23.

FIG. 4 shows a device according to the invention for slicing food products in block form. The food product blocks (not shown) are conveyed in the direction of a blade 27 by the conveyor belt 32, said blade slicing the food product block into slices. The blade 27 is connected non-rotatably with a shaft 30, which is driven in rotation by a motor (not shown). The blade 27 is mounted axially displaceably on the shaft 30. The person skilled in the art will understand that the shaft may also itself be mounted in axially displaceable manner. Between the cutting plane 26 of the blade 27 and the cutting guide 28, with which the blade interacts during cutting, there is a cutting gap 29, which is adjustable and which should be as small as possible for an optimum cutting result. The blade must not come into contact with the cutting guide 28 during cutting, however. To adjust the cutting gap, the device according to the invention comprises an adjusting limit stop 31, which is shown in the present illustration in its basic position, i.e. it has been drawn back comparatively far from the blade. The adjusting limit stop 31 may be displaced axially, as illustrated by the double-headed arrow. This axial displacement may be effected manually, but is preferably effected by an adjusting drive, which is in turn connected with a central control unit, such that for example a given position of the adjusting limit stop and thus a given width of the cutting gap may be preselected on the display of the machine. Axial displacement of the adjusting limit stop in the direction of the blade is limited in the present case by the nuts 41.

FIG. 5 shows the device for slicing food products according to FIG. 1, wherein in this Figure the adjusting limit stop is shown in its adjusting position, i.e. it has been moved leftwards towards the blade by the actuator or manually.

Once the adjusting limit stop has been moved to the left, the blade, as shown in FIG. 6, is displaced axially to the left until it comes into contact with the adjusting limit stop. Axial displacement of the blade is effected in the present case by a motor. Contact between the blade and the adjusting limit stop may be detected for example by a contact sensor, which is located in the adjusting limit stop, or through the current consumption of the motor which effects axial displacement of the blade. As soon as the blade has come into contact with the adjusting limit stop, the cutting gap 29 exhibits the desired width and the adjusting limit stop may, as shown in FIG. 7, be moved back into its basic position.

Adjustment of the adjusting gap may take place prior to slicing of a new food product block and/or after a blade change. With the device according to the invention, it is possible to adjust the cutting gap both when the blade is at a standstill and when it is rotating. Adjustment of a rotating blade has the advantage that changes to the cutting plane, for example as a result of centrifugal forces or thermal influences, may be compensated.

FIG. 8 shows a further slicing machine according to the invention. These days, slicing machines sever slices from a block-form food product, for example a sausage, ham or cheese block, at relatively high rates. The food products lie on a product support and are conveyed gradually or continuously thereby towards the cutting blade. To achieve very high cutting performance, it is necessary to provide idle cuts, i.e. movements of the cutting blade during which no slice is severed from the block of food product. Such idle cuts are produced for example by preferably axial displacement of the blade. Axial displacement of the blade is shown in particular in FIG. 8. The device illustrated therein comprises a rotating blade 2 which interacts with a cutting guide 28. The blade 27 is mounted non-rotatably at the left-hand end of the shaft 30. At its right-hand end, the shaft 30 comprises a means 40 which is connected directly or indirectly with a motor which drives the shaft 30. Furthermore, the device according to the invention comprises coupling rods 33 which are connected by means of ball-and-socket joints at both their ends 34, 35 with receiving rings 36, 37. The receiving ring 36 is mounted non-rotatably but axially displaceably on the shaft 30. The receiving ring 37 is mounted rotatably on the shaft 30 and is driven by the means 39, which is connected directly or indirectly with a motor. In the example illustrated, the means 39 and 40 are controlled synchronously. Since the coupling rods 33 are located in a vertical position, the distance between the blade 27 and the cutting guide 28 is at its largest in the present Figure. In this position of the blade, idle cuts are produced.

FIG. 9 shows a situation in which the coupling rods 33 have been twisted. Because the axial length relative to the axis of rotation has been reduced reversibly by this turning, the receiving ring 36 and thus the blade 27 are drawn back axially in the direction of the cutting guide 28. The distance between the cutting plane and the blade now corresponds to the desired cutting gap and slices are severed from the food product block.

Twisting of the coupling rods is effected by a temporary change in the rotational speed of the means 39 in comparison to the rotational speed of the means 40, wherein the change in rotational speed has to be effected in such a way that either the rotational speed of the means 39 is slowed down in comparison to the rotational speed of the means 40 or the rotational speed of the means 40 is increased in comparison to the rotational speed of the means 39. After termination of the twisting movement, the two means 39, 40 once again rotate at the same speed. A larger distance may again be achieved between the blade 27 and the cutting guide 28 in such a way that the coupling rods 33 are brought into a vertical position. This is effected either in that the rotational speed of the means 39 is accelerated for a short time and/or in that the rotational speed of the means 40 is reduced for a short time.

### LIST OF REFERENCE NUMERALS

1 Food product
2 Cutting blade
3 Axis of rotation
4 Counterweight
5 Drive shaft
6 Spindle
7 Hub
8, Sleeve with internal
9 thread
10 Drive shaft bearing system
11 Toothed wheel
12 Toothed wheel
13 Thread
14 Thread
15 Cutting guide
16 Balance weight
16′ Balance weight
17 Machine frame
18 Cutting edge
19 Bushes
20 Spring
21 Disks
22 Cooling (inlet)
23 Cooling (outlet)
24 Blade holder
25 Toothed wheel
26 Cutting plane
27 Blade
28 Cutting edge
29 Cutting gap
30 Drive shaft
31 Adjusting means
32 Conveyor belt
33 Displacement means
34 First end of the displacement means 33
35 Second end of the displacement means 33
36, 37 Receiving ring
38 Ball bearing
39 Receiving ring drive
40 Drive for drive shaft 5
41 Nut
42 Double-headed arrow

1-40. (canceled)

41. A slicing machine for slicing food products (1), in particular blocks of sausage, meat or cheese, having a rotating cutting blade (2), which is mounted so as to be displaceable parallel to its axis of rotation (3), characterised in that it comprises a counterweight (4), which may be displaced in the opposite direction from the cutting blade (2).

42. A slicing machine according to claim 41, characterised in that displacement of the cutting blade (2) and/or of the counterweight (4) is preferably effected by a feedback-controllable drive (6, 8, 9).

43. A slicing machine according to claim 41, characterised in that displacement of the cutting blade (2) and/or of the counterweight (4) takes place independently of the rotational speed of the cutting blade.

44. A slicing machine according to claim 41, characterised in that the cutting blade comprises a drive shaft (5) and in that the cutting blade (2) and/or the counterweight (4) is(are) mounted so as to be displaceable along the drive shaft (5).

45. A slicing machine according claim 41, characterised in that displacement of the cutting blade (2) and/or of the counterweight (4) is effected with at least one spindle (6).

46. A slicing machine according to claim 45, characterised in that the spindle (6) interacts with the thread (13, 14) of at least one sleeve (8, 9), which is connected with the cutting blade or the counterweight.

47. A slicing machine according to claim 46, characterised in that the threads (13, 14) of the sleeves (8, 9) are different.

48. A slicing machine according to claim 1, wherein the displacement mechanism (6, 8, 9) of the blade (2) and/or of the counterweight (4) is temperature-controlled, preferably cooled.

49. A slicing machine according to claim 1, wherein the blade (2) and/or the blade holder (7) is mounted using a means which may be bent and released again, preferably a disk.

50. A method for axial displacement of cutting blades during operation, characterised in that a counterweight (4) on a drive shaft (5) of the cutting blade is displaced in the opposite direction from the cutting blade (2).

51. A method according to claim 50, characterised in that displacement is effected synchronously.

52. A method according to claim 50, characterised in that displacement of the cutting blade (2) and of the counterweight (4) is effected by a drive (6).

53. Use of counterweights (4) displaceably axially in the opposite direction from a cutting blade (2) to stabilise running of the cutting blade (2) of a slicing machine, which blade is mounted so as to be displaceable parallel to its axis of rotation (3).

54. Use according to claim 53, characterised in that forces and/or moments arising during displacement of the blade are compensated.

55. Use according to claim 53, characterised in that the zero point may be adjusted by axial displacement of the cutting blade (2) of a slicing machine.

56. Use according to claim 53, characterised in that the torque of the drive of the cutting blade is measured during displacement.

57. Use of the axial displacement of the cutting blade for adjustment of the cutting gap between the cutting blade and a cutting guide during operation of the blade, characterised in that expansion phenomena of the blade caused by thermal expansion and/or centrifugal forces are compensated.

58. Use according to claim 57, characterised in that the desired cutting gap is set or modified via a display on the machine.

59. Use according to claim 57, characterised in that the mechanical behaviour of the blade is stored as a model and/or by means of characteristic diagrams in the machine control system, for example a computer.

60. Use according to claim 59, characterised in that these data are used for adjustment or readjustment of the cutting gap when the cutting blade is in operation.

61. A device for slicing food products having a blade (27) exhibiting a cutting plane (26) and driven in rotation by a drive shaft (30) and having a cutting edge (28), the blade (27) being mounted so as to be displaceable parallel to its drive shaft (30) for adjustment of the cutting gap (29) between the cutting plane (26) and the cutting edge (28), characterised in that it comprises an adjusting limit stop (31) with which the cutting gap (29) may be established.

62. A device according to claim 61, characterised in that the adjusting limit stop may be moved between a basic position and an adjusting position.

63. A device according to claim 62, characterised in that adjustment of the adjusting limit stop is effected manually or by an actuator.

64. A device according to claim 41, characterised in that the adjusting limit stop is a contact sensor.

65. A device according to claim 41, characterised in that axial displacement of the blade is effected with a motor.

66. A device according to claim 65, characterised in that the current consumption of the motor system may be measured and the motor is feedback-controllable by means of the current consumption.

67. A device according to claim 41, characterised in that the position of the adjusting limit stop and thus the width of the cutting gap may preferably be selected by means of a display.

68. A device according to claim 41, characterised in that adjustment of the cutting gap is effected when the blade is stationary or rotating.

69. A device according to claim 41, characterised in that the axial position of the blade is not changed after it has come into contact with the adjusting limit stop.

70. A method of adjusting the cutting gap using a device according to claim 61, characterised in that the adjusting limit stop is moved from its basic position into its adjusting position corresponding to the desired cutting gap and in that the blade is displaced axially until it comes into contact with the adjusting limit stop.

71. A method according to claim 70, characterised in that the adjusting limit stop is brought into its basic position after adjustment of the cutting gap.

72. A device for slicing food products, having a rotating cutting blade (27), which is displaceable parallel to its axis of rotation (30), characterised in that displacement is effected with at least one means (33) comprising a first (34) and second (35) end, the position of which relative to one another may be modified.

73. A device according to claim 72, characterised in that the means is a coupling rod or a leaf spring.

74. A device according to claim 72, characterised in that the first and second ends may be twisted relative to one another.

75. A device according to claim 72, characterised in that the means (33) is bent.
